(19) United States
(12) Patent Application Publication
(10) Pub. No.: US 2008/0044217 A1
(43) Pub. Date: Feb. 21, 2008

(54) Writing instrument

(76) Inventor: Jake Russell, Thousand Oaks, CA (US)

Correspondence Address: IRVING KESCHNER, 21535 HAWTHORNE BOULEVARD, SUITE 385, TORRANCE, CA, 90503, US

(21) Appl. No.: 11/505,535

(22) Filed: Aug. 18, 2006

(51) Int. Cl. A46B 5/04; B43K 27/08

(52) U.S. Cl. 401/7; 401/35

(57) ABSTRACT

A writing device that contains dual writing implements, the device being positioned preferably on the index finger of a user. The device comprises a shroud-like member having an opening to receive a user's index finger. A writing implement is mounted to each side of the member. Writing is accomplished by rotating the device to a first position to write with a first implement and rotated to a second position to write with the other implement.

### BACKGROUND OF THE INVENTION

1. Field of the Invention

The present invention relates to writing instruments which are mounted on the finger of a user.

2. Description of the Prior Art

A number of devices have been known in the prior art wherein the writing component is supported by the finger of a user. Examples of this prior art are as follows:

U.S. Pat. No. 69.126 to Price is directed to a pen and pencil holder and includes a thimble for placement on the fore-finger and a pen or a pencil that is mounted parallel to the top surface of the thimble.

U.S. Pat. No. 36,652 to Jacobs is directed to a pen and pencil case, the device including a tubular device with a pen, pencil or brush holder mounted on the outer circumference of the tubular device.

U.S. Pat. No. 281,525 to Lane is directed to a pen or pencil holder, the device including a tube and a pen or pencil slideably engaged on the tube with clamp.

U.S. Pat. No. 391,199 to Seabough is directed to a writing pen, the device including a thimble or sleeve that is formed to fit a finger from the lower joint to the end of the finger nail. Upon the upper side of the sleeve, a socket is formed into which a pen is positioned.

U.S. Pat. No. 4,177,698 to Greneker is directed to a finger fit implement, this device including a shaped hollow member that has an opening at one end to accommodate the entry of a finger and an opposed off centered tapered internal end to be mated against the tip and nail portion of the finger. The opposed end portion has an external fitting means for attachment of various tool elements.

All these prior patents disclose devices having a single writing implement. Thus, if the implement is damaged, time and effort is required to replace the implement with a new one.

What is desired is to provide a finger mounted writing instrument that has more than one writing implement to enable the user to continue writing even if one of the writing implements no longer functions.

### SUMMARY OF THE INVENTION

The present invention provides a writing instrument that contains dual writing implements, the instrument being positioned preferably on the index finger of a user.

The instrument comprises an elongated, hood-like member having an opening to receive a user's index finger. A writing implement is mounted to each side of the member. Writing is accomplished by rotating the device to a first position to write with one implement and rotated to a second position to write with the other implement.

### DESCRIPTION OF THE DRAWINGS

For a better understanding of the present invention as well as other objects and further features thereof, reference is made to the following description which is to be read in conjunction with the accompanying drawing wherein:

FIG. 1 is a perspective view of the writing device of the present invention;

FIG. 2 is a top plan view of the device shown in FIG. 1;

FIG. 3 is a front plan view of the device shown in FIG. 1; and

FIG. 4 is a side plan view of the device shown in FIG. 1.

### DESCRIPTION OF THE INVENTION

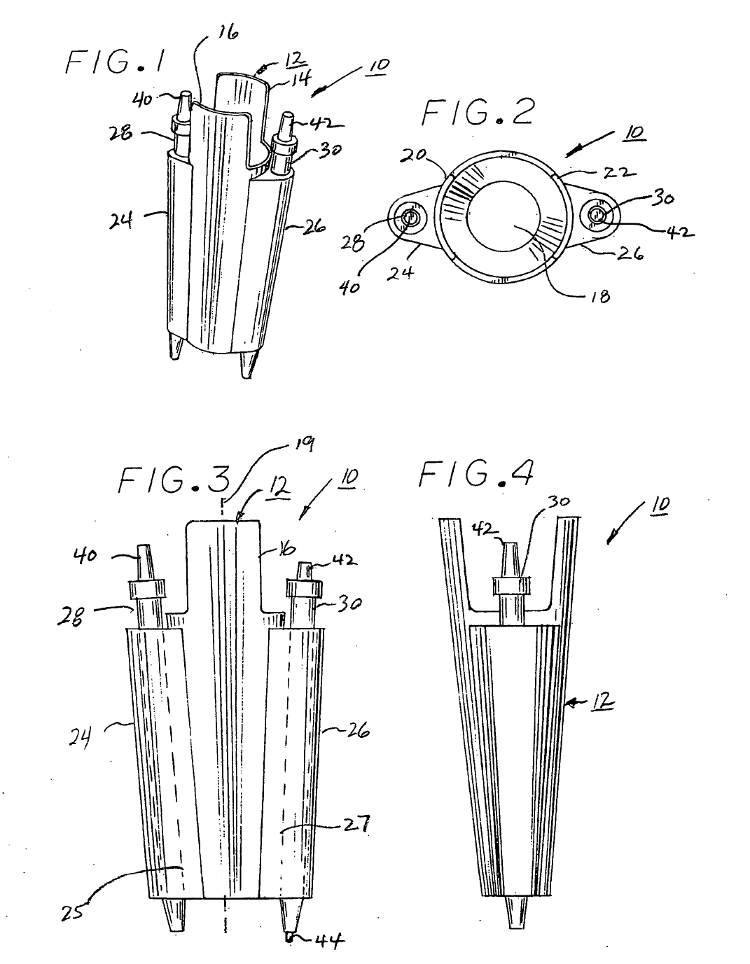

Referring now to FIGS. 1-4, writing device 10 of the present invention is illustrated. Device 10 comprises an elongated member portion 12 having sides 14 and 16 and an opening 18. Mounted to the sides 20 and 22 of portion 12 are elongated members 24 and 26, respectively, having apertures 25 and 27 formed therein. Members 24 and 26 are adapted to receive and hold writing implements 28 and 30, respectively, as illustrated and may be mounted to the sides of portion 12 as separate components or can be integrally formed with portion 12.

In operation, writing implements, such as pens or pencils, are inserted into apertures 25 and 27. The outside diameters of the writing implements are selected so that they can be press-fit into the apertures 25 and 27 whereby they are securely held therein. The user then inserts his/her index finger into opening 18, device 10 then being ready for use. In order to write using implement 28, for example, the user rotates the finger slightly about the longitudinal axis 19 of member portion 12 so that the tip of implement 28 contacts the surface of a writing material (not shown). In order to use implement 30, the user rotates the index finger slightly in the opposite direction about axis 19 such that the tip thereof now contacts the surface of the writing material. The design of device 10 is such that only one of the implements contact the writing surface at a time.

When the writing implements 28 and 30 are pens that have buttons 40 and 42, respectively, to retract (off position) or force forward (on position) the pen writing tips (only tip 44 is illustrated), the present invention provides a unique way for the user to interact with buttons 40 and 42. Specifically, the writing tips are moved from a retracted to a forward position (and vice versa) by the user moving the finger having device 10 thereon towards the palm of that hand, contact with the palm being sufficient to control the operation of buttons 40 and 42.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A writing instrument mounted on the finger of a user comprising
an elongated body having a longitudinal axis, said elongated body having an opening extending therethrough and first and second side portions;
first and second elongated members positioned in contact with said first and second side portions, respectively, said first and second side portions having openings extending therethrough; and
first and second writing implements are positioned in the openings formed in said first and second side portions, respectively, a finger of a user positioned within the opening formed in said elongated body.

2. The writing instrument of claim 1 wherein said first and second elongated members are attached to said first and second side portions, respectively.

3. The writing instrument of claim 1 wherein said first and second elongated members are integral with said elongated body.

4. The writing instrument of claim 1 wherein said user rotates said instrument in a first direction about said longitudinal axis whereby said first writing implement is enabled to mark the surface of a writing material.

5. The writing instrument of claim 4 wherein said user rotates said instrument in a second direction about said longitudinal axis whereby said second writing implement is enabled to mark the surface of said writing material.
